(19) United States
(12) Patent Application Publication
(10) Pub. No.: US 2026/0139518 A1
(43) Pub. Date: May 21, 2026

(54) JAM-RESISTANT DRAWER INTERLOCK

(71) Applicant: WESKO LOCKS LTD., Mississauga (CA)

(72) Inventor: Tonino SABELLI, Mississauga (CA)

(73) Assignee: WESKO LOCKS LTD., Mississauga (CA)

(21) Appl. No.: 19/395,528

(22) Filed: Nov. 20, 2025

Related U.S. Application Data
(60) Provisional application No. 63/723,171, filed on Nov. 21, 2024.

(51) Int. Cl. E05B 65/463

(52) U.S. Cl. CPC E05B 65/463

(57) ABSTRACT

An interlock system of a cabinet having two or more drawers includes an interlock swivel associated with a lock mechanism for each drawer. Each drawer includes a drawer pin movable along with the respective drawer and the interlock swivel is mounted so as to be movable between first and second positions. The interlock swivel comprises a pin capture slot, and the interlock swivel is constructed and arranged to be in the first position with the drawer pin of a respective one of the drawers disposed within the pin capture slot when the respective drawer is in the closed position. The interlock swivel is configured so that the drawer pin will enter the pin capture slot when the drawer is closed, even if the drawer pin is not aligned with the pin capture slot, to avoid a jam of the interlock swivel.

### CROSS REFERENCE TO RELATED APPLICATION

This application claims the benefit under 35 U.S.C. § 119(e) of the filing date of United States Provisional Application Serial No. 63/723,171 filed November 21, 2024, the disclosure of which is incorporated herein by reference.

### FIELD OF THE DISCLOSURE

This disclosure relates to drawer interlocks that are resistant to jams due to mis-aligned drawer pins that are not properly aligned with a lock mechanism of the interlock.

### BACKGROUND

Interlock assemblies for cabinets and other storage units having multiple drawers permit only one of the drawers to be pulled out at a time. Examples of such interlock assemblies are described in commonly-assigned U.S. Patent No. 10,145,149 as well as in U.S. Patent No. 4,768,844 and German Utility Model DE 202018104659 U1.

The interlock assembly includes a vertically-stacked array of lock mechanisms, one lock mechanism associated with each respective drawer of the cabinet or storage unit. Each drawer may include a pin that is movable with the respective drawer and actuates the respective lock mechanism to set the respective lock mechanism in a first (or locked) position or configuration when the respective drawer is closed and a second (or unlocked) position or configuration when the respective drawer is not closed (e.g., partially to completely open). When a lock mechanism is in the first position, the associated drawer pin should be captured by the lock mechanism to prevent the respective drawer from being opened without actuating the lock mechanism from the first position to the second position. When a lock mechanism associated with a drawer is in the second configuration, because the respective drawer is opened, the interlock assembly locks out the remaining lock mechanisms, thereby preventing the remaining lock mechanisms from being actuated from their first configurations to their second configurations and thereby preventing the drawers associated with the remaining lock mechanisms from being opened. When the opened drawer is closed, the drawer pin of that drawer actuates the respective lock mechanism from the second position or configuration to the first position or configuration, so that one of the other drawers can then be opened.

If a drawer pin associated with a lock mechanism is not properly aligned with the associated lock mechanism, e.g., because of manufacturing or assembly tolerances, the drawer pin may not properly engage the lock mechanism when the respective drawer is moved from the opened position to the closed position. This can result in a jam of the associated lock mechanism, whereby the associated lock mechanism is moved to its first (or locked) position but the associated drawer pin is not captured by the lock mechanism. The jammed lock mechanism may prevent the associated drawer from being fully closed, and the associated drawer will not be locked in a closed position if another drawer of the cabinet or storage unit is opened. To correct the jammed lock mechanism, the associated drawer must be removed from the cabinet or storage unit and the lock mechanism must be reset to the second position.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The present disclosure describes a drawer interlock that is configured to operate properly, and avoid jamming of the interlock, even when a drawer pin for actuating the interlock is not properly aligned with the interlock.

Implementations of the disclosure can be described in view of the following embodiments, the features of which can be combined in any reasonable manner.

### Some embodiments encompass:

Embodiment 1. An interlock swivel for an interlock system of a cabinet having two or more drawers, each drawer being movable between a closed position and an open position, and each drawer including a drawer pin movable with the respective drawer, wherein the interlock swivel is mounted with respect to the cabinet so as to be movable between a first position and a second position, and wherein the interlock swivel comprises: a first leg; and a second leg spaced apart from the first leg to define an open-ended pin capture slot between the first leg and the second leg, wherein the interlock swivel is constructed and arranged to be in the first position with the drawer pin of a respective one of the two or more drawers disposed within the pin capture slot when the respective drawer is in the closed position, and wherein movement of the respective drawer from the closed position to the open position causes the drawer pin to engage the first leg and cause the interlock swivel to move from the first position to the second position, and wherein the first leg includes an end surface oriented at an obtuse angle with respect to a side of the first leg forming one side of the pin capture slot, so that if the drawer pin contacts the end surface of the first leg of the interlock swivel disposed in the second position as the respective drawer is moved from the open position to the closed position, inter-engagement between the drawer pin and the end surface will cause the interlock swivel to deflect to enable the drawer pin to enter the pin capture slot so that continued movement of the respective drawer to the closed position will return the interlock swivel to the first position with the drawer pin of the respective drawer disposed in the pin capture slot.

Embodiment 2. An interlock swivel for an interlock system of a cabinet having two or more drawers, each drawer being movable along a drawer axis between a closed position and an open position, and each drawer including a drawer pin movable with the respective drawer, wherein the interlock swivel is mounted with respect to the cabinet so as to be movable between a first position and a second position, and wherein the interlock swivel comprises: a first leg; and a second leg spaced apart from the first leg to define an open-ended pin capture slot between the first leg and the second leg, wherein the interlock swivel is constructed and arranged to be in the first position with the drawer pin of a respective one of the two or more drawers disposed within the pin capture slot when the respective drawer is in the closed position, and wherein movement of the respective drawer from the closed position to the open position causes the drawer pin to engage the first leg and cause the interlock swivel to move from the first position to the second position, and wherein the first leg includes an end surface oriented at an acute angle with respect to the drawer axis when the interlock swivel is in the second position, so that if the drawer pin contacts the end surface of the first leg of the interlock swivel disposed in the second position as the respective drawer is moved from the open position to the closed position, inter-engagement between the drawer pin and the end surface will cause the interlock swivel to deflect to enable the drawer pin to enter the pin capture slot so that continued movement of the respective drawer to the closed position will return the interlock swivel to the first position with the drawer pin of the respective drawer disposed in the pin capture slot.

Embodiment 3. An interlock assembly for a cabinet having two or more drawers, wherein the interlock assembly comprises a lock mechanism associated with each of the two or more drawers, and wherein each lock mechanism includes the interlock swivel of embodiment 1 or 2 .

Embodiment 4. An interlock system for a cabinet having two or more drawers, wherein the interlock system comprises the interlock assembly of embodiment 3 and a drawer pin associated with each of the two or more drawers.

Embodiment 5. A lock mechanism for an interlock assembly for a cabinet having two or more drawers, each drawer being movable between a closed position and an open position, and each drawer including a drawer pin movable with the respective drawer, wherein the lock mechanism comprises: the interlock swivel of embodiment 1 or embodiment 2, wherein the interlock swivel is configured to pivot about a pivot axis between the first position and the second position, and wherein the interlock swivel includes a cam surface; and a cam follower including a cooperating cam surface operative engaged with the cam surface of the interlock swivel so that movement of the interlock swivel from the first position to the second position causes the cam follower to move from a first position to a second position, wherein the second position is further from the pivot axis than the first position.

Embodiment 6. An interlock assembly for a cabinet having two or more drawers, wherein the interlock assembly comprises: the lock mechanism of embodiment 5 associated with each of the two or more drawers; a track having a first end and a second end, wherein each lock mechanism is attached to a different longitudinally-spaced position on the track, and wherein at least the cam follower of each lock mechanism is configured to move longitudinally along the track; a spring disposed at a position along the track between a fixed spring retainer and a movable spring retainer; and one or more slide bars, each slide bar being coupled to the track between one lock mechanism and an adjacent lock mechanism, and wherein each slide bar is configured to transfer motion of the cam follower of the one lock mechanism from the first position to the second position to the adjacent lock mechanism.

Embodiment 7. An interlock assembly of embodiment , further comprising a slide bar coupled to the track between an uppermost one of the lock mechanisms and the movable spring retainer, wherein each slide bar is configured to transfer motion of the cam follower of the uppermost lock mechanism to the movable spring retainer. Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1A is a broken, front view of a prior art drawer interlock assembly, with all locking mechanisms in a first, or locked, position with a respective drawer pin captured in each lock mechanism.

FIG. 1B is a broken, front view of the prior art drawer interlock assembly, with one locking mechanism in a second, or unlocked, position with the respective drawer pin released from the lock mechanism as the respective drawer is opened.

FIG. 2A is a partial front view of the prior art drawer interlock assembly with one of the lock mechanisms in the second, or unlocked, position and the respective drawer pin engaging the lock mechanism as the respective drawer is closed.

FIG. 2B is a partial front view of the prior art drawer interlock assembly with one of the lock mechanisms in the first, or locked, position and the respective drawer pin captured in the lock mechanism after the respective drawer is closed.

FIGS. 3A – 3E are partial front views of the prior art drawer interlock assembly

showing a sequence whereby a misaligned associated drawer pin is first released from the lock mechanism when the respective drawer is opened and then jams the lock mechanism when the respective drawer is attempted to be closed, causing the lock mechanism to be in the first, or locked, position without the respective drawer pin captured in the lock mechanism.

FIG. 4A is a partial front view of a drawer lock mechanism as described herein in a first, or locked, position with the respective drawer pin captured in the lock mechanism.

FIG. 4B is a partial front view of the drawer lock mechanism as described herein in a second, or unlocked, position with the respective drawer pin released from the lock mechanism.

FIG. 5 is an exploded, top perspective view of a lock mechanism of the drawer interlock assembly described herein.

FIG. 6 is an exploded, bottom perspective view of the lock mechanism of the drawer interlock assembly described herein.

FIG. 7 is a partial perspective view of a drawer with a drawer pin for actuating a lock mechanism of a drawer interlock assembly.

FIG. 8 is a partial perspective view of the inside of a cabinet with a drawer interlock assembly and drawer guides mounted to an inner wall of the cabinet.

FIG. 9 is a plan view an interlock swivel of a lock mechanism of the prior art interlock assembly.

FIG. 10 is a plan view of an interlock swivel of a lock mechanism of the interlock assembly described here.

FIGS. 11A – 11G are partial front views of the drawer interlock assembly described herein showing a sequence whereby a misaligned associated drawer pin is first released from the lock mechanism when the respective drawer is opened, the associated drawer pin engages the lock mechanism as the respective drawer is attempted to be closed, causing the lock mechanism deflect to permit the drawer pin to be captured by the lock mechanism, and the drawer pin actuates the lock mechanism to be in the first, or locked, position when the respective drawer is closed with the respective drawer pin captured in the lock mechanism.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

### Definitions

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

References in the specification to “one embodiment,” “an embodiment,” a “further embodiment,” “an example,” “an exemplary embodiment,” “some aspects,” “a further aspect,” “aspects,” etc., indicate that the embodiment, example, or aspect described may include a particular feature, structure, or characteristic, but every embodiment encompassed by this disclosure may not necessarily include the particular feature, structure, or characteristic or combination thereof. Moreover, such phrases are not necessarily referring to the same embodiment, example, or aspect. Further, when a particular feature, structure, or characteristic is described in connection with an embodiment, such feature, structure, or characteristic is also a description in connection with other embodiments, examples, or aspects with which it is not incompatible, whether or not explicitly described.

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, forward, backward, sideward, sideways, etc., are used for convenience in referring to such component, apparatus, location, feature, or a portion thereof or movement, force, or other dynamic action represented in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, linked, coupled, or similar terms or variations of such terms, shall encompass both a direct relationship in which the first component, structure, or portion thereof is in direct contact with the second component, structure, or portion thereof or there are one or more intervening components, structures, or portions thereof between the first component, structure, or portion thereof and the second component, structure, or portion thereof.

Unless otherwise stated, any specific dimensions mentioned in this description are merely representative of an exemplary implementation of a device embodying aspects of the disclosure and are not intended to be limiting.

To the extent used herein, the terms “about” or “approximately” apply to all numeric values and terms indicating specific physical orientations or relationships such as horizontal, vertical, parallel, perpendicular, concentric, or similar terms, specified herein, whether or not explicitly indicated. This term generally refers to a range of numbers, orientations, and relationships that one of ordinary skill in the art would consider as a reasonable amount of deviation to the recited numeric values, orientations, and relationships (i.e., having the equivalent function or result) in the context of the present disclosure. For example, and not intended to be limiting, this term can be construed as including a deviation of ±10 percent of the given numeric value, orientation, or relationship, provided such a deviation does not alter the end function or result of the stated value, orientation, or relationship. Therefore, under some circumstances as would be appreciated by one of ordinary skill in the art a value of about or approximately 1% can be construed to be a range from 0.9% to 1.1%.

To the extent used herein, the term “adjacent” refers to being near (spatial proximity) or adjoining (physical contact). Adjacent objects or portions thereof can be spaced apart from one another or can be in actual or direct physical contact with one another. In some instances, adjacent objects or portions thereof can be coupled to one another or can be formed integrally with one another.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

To the extent used herein, the terms “optional” and “optionally” or the term “may” (e.g., as in the phrase “may include,” “may comprise,” “may produce,” “may provide,” or similar phrases) mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

To the extent used herein, the terms “first” and “second” preceding the name of an element (e.g., a component, apparatus, location, feature, or a portion thereof or a direction of movement, force, or other dynamic action) are used for identification purposes to distinguish between similar elements, and are not intended to necessarily imply order, nor are the terms “first” and “second” intended to preclude the inclusion of additional similar elements. Furthermore, use of the term “first” preceding the name of an element (e.g., a component, apparatus, location, feature, or a portion thereof or a direction of movement, force, or other dynamic action) does not necessarily imply or require that there be additional, e.g., “second,” “third,” etc., such element(s).

To the extent used herein, the terms or phrases “configured to,” “adapted to,” “operable to,” “constructed and arranged to,” and similar terms mean that the subject of the term or phrase includes, constitutes, or otherwise encompasses the requisite structure(s), mechanism(s), arrangement(s), component(s), material(s), algorithm(s), circuit(s), programming, etc. to perform a specified function, task, or tasks or achieve a specified output or characteristic, either automatically or perpetually or selectively when called upon to do so.

### Description

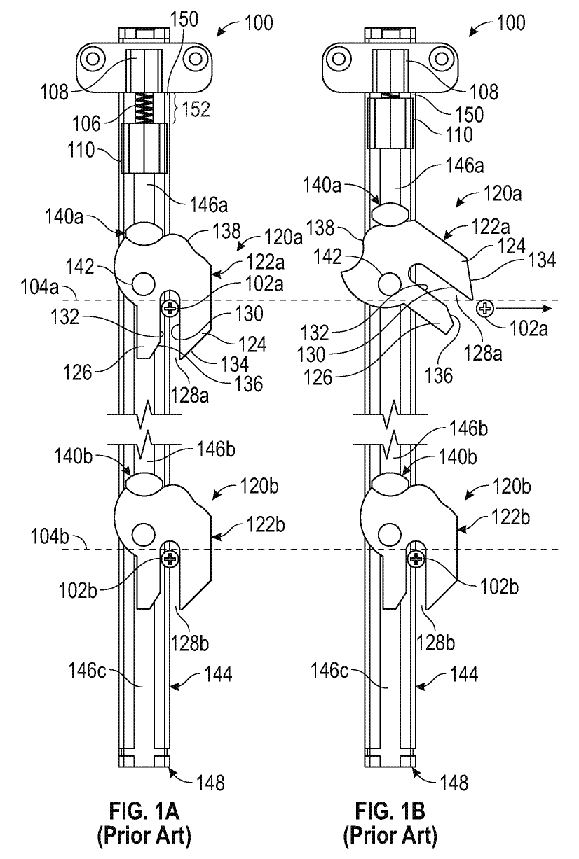

A prior art interlock assembly 100 is shown in FIGS. 1A and 1B. The interlock assembly 100 may be attached to an inside wall of a cabinet or storage unit (not shown in FIGS. 1A and 1B) adjacent to drawers (not shown in FIGS. 1A and 1B) that are movable between open and closed positions along respective drawer axes 104a, 104b. Interlock assembly 100 includes two lock mechanisms 120a, 120b, each of which is engageable with a drawer pin 102a, 102b of a respective drawer. Interlock assembly 100 as shown in FIGS. 1A and 1B has two lock mechanisms 120a, 120b to accommodate two respective drawers. In other variants, the interlock assembly 100 may have more than two lock mechanisms to accommodate a like number of more than two drawers.

Lock mechanisms 120a, 120b are coupled to a vertical track 144, which may comprise a C-channel, so to be longitudinally movable along the length of the track 144. Interlock assembly 100 includes a spring 106 disposed at a first end 150, (e.g., a top end), of track 144 between a fixed spring retainer 108 and a movable spring retainer 110. Interlock assembly 100 further includes a first slide bar 146a disposed within track 144 between lock mechanism 120a and movable spring retainer 110, a second slide bar 146b disposed within track 144 between lock mechanism 120b and lock mechanism 120a, and a third slide bar 146c disposed within track 144 between a second end 148 (e.g., a lower end) of track 144 and lock mechanism 120b.

Lock mechanism 120a includes an interlock swivel 122a that is operatively coupled with a cam follower 140a, and lock mechanism 120b includes an interlock swivel 122b that is operatively coupled with a cam follower 140b. Interlock swivels 122a, 122b are engaged by drawer pins 102a, 102b, respectively, to move the interlock swivels 122a, 122b between first (locked) position (interlock swivels 122a, 122b are in the first position in FIG. 1A) and second (unlocked) position (interlock swivel 122a is in the second position in FIG. 1B, and interlock swivel 122b is in the first position in FIG. 1B) as the respective drawers are moved between open and closed positions, as will be described herein.

As interlock swivels 122a, 122b are substantially identical in configuration and function, a detailed description will be limited to interlock swivel 122a.

Interlock swivel 122a includes a first leg 124 and a second leg 126 defining a pin capture slot 128a therebetween. Interlock swivels 122a, 122b are both shown in a first (locked) position in FIG. 1A with the respective drawer pins 102a, 102b disposed within the respective pin capture slots 128a, 128b. With interlock swivels 120a, 120b in the locked positions as shown in FIG. 1A, there is a gap 152 between fixed spring retainer 108 and movable spring retainer 110.

Interlock swivel 122a is pivotably mounted to a pivot pin 142, which extends from a swivel base (not shown) having a T-shaped base slide (not shown), or other slidable connection, disposed within the track 144 to permit pivot pin 142 and interlock swivel 122a to slide longitudinally along track 144. Interlock swivel 122a includes a cam surface 138 engaged with a cam follower 140a mounted to a follower base (not shown) having a T-shaped base slide (not shown), or other slidable connection, disposed within track 144 to permit the cam follower 140a to slide longitudinally along track 144.

As the drawer to which drawer pin 102a is moved along drawer axis 104a from the closed position toward the open position (left to right in FIG. 1A), pin 102a contacts a first surface 130 of first leg 124 forming a first side of pin capture slot 128a to cause the interlock swivel 122a to pivot counterclockwise about a pivot axis defined by pin 142. As the drawer continues to be moved toward the open position, drawer pin 102a slides along first surface 130 and continues to cause counterclockwise rotation of the interlock swivel 122a until, as shown in FIG. 1B, interlock swivel 122a is sufficiently rotated to its second position to allow drawer pin 102(a) to escape pin capture slot 128a. As interlock swivel 122a rotates counterclockwise, cam surface 138 engaging cam follower 140a causes the cam follower 140a to move with respect to the interlock swivel 122a along track 144 toward first end 150 from a first position (shown in FIG. 1A) to a second position (shown in FIG. 1B), the second position being further from the pivot axis of pin 142 than the first position. Movement of the cam follower 140a is transferred by slide bar 146a to the movable spring retainer 110 to reduce or substantially close the gap 152 between the movable spring retainer 110 and the fixed spring retainer 108, as shown in FIG. 1B. With little or no gap between the movable spring retainer 110 and the fixed spring retainer 108, any attempt to open the drawer to which the drawer pin 102b is attached and rotate interlock swivel 122b will be blocked because the slide bar 146b disposed between lock mechanism 120b and lock mechanism 120a will prevent relative longitudinal movement of the cam follower 140b of lock mechanism 120b, thereby preventing rotation of the interlock swivel 122b from the first (locked) position shown in FIG. 1A to the second (unlocked) position.

Similarly, if lock mechanism 120a were in the first position of FIG. 1A, and interlock swivel 122b were rotated counterclockwise from the first position shown in FIG. 1A to a second position by movement of the drawer to which drawer pin 102b is attached from the closed position to the open position, a cam surface of interlock swivel 122b engaging cam follower 140b causes the cam follower 140b to move with respect to the interlock swivel 122b along track 144 toward first end 150. Movement of the cam follower 140b is transferred by slide bar 146b, interlock swivel 122a, cam follower 140a, and slide bar 146a to the movable spring retainer 110 to reduce or substantially close the gap 152 between the movable spring retainer 110 and the fixed spring retainer 108, as shown in FIG. 1B. With little or no gap between the movable spring retainer 110 and the fixed spring retainer 108, any attempt to open the drawer to which the drawer pin 102a is attached and rotate interlock swivel 122a will be blocked because the slide bar 146a disposed between lock mechanism 120a and movable spring retainer 110 will prevent relative longitudinal movement of the cam follower 140a of lock mechanism 120a, thereby preventing rotation of the interlock swivel 122a from the first (locked) position shown in FIG. 1A to the second (unlocked) position shown in FIG. 1B.

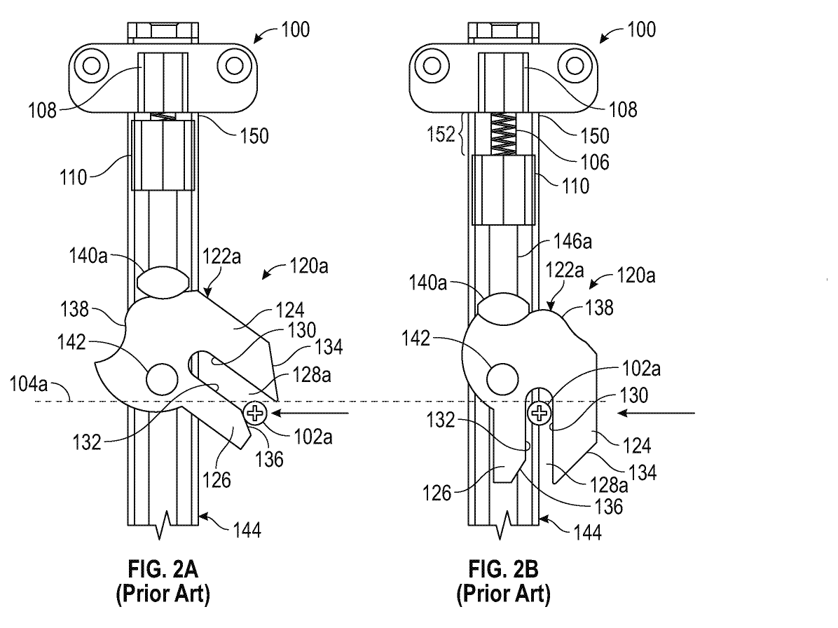

Referring to FIGS. 2A and 2B, showing only lock mechanism 120a of interlock assembly 100, as the drawer to which drawer pin 102a is attached is moved from the open position to the closed position (right to left along drawer axis 104a in FIGS. 2A and 2B) drawer pin 102a contacts a beveled second end surface 136 of second leg 126 to begin rotating the interlock swivel 122a clockwise about pivot pin 142. As the drawer is further moved toward the closed position, and interlock swivel 122a rotates clockwise, drawer pin 102a will slide along a second surface 132 of second leg 126 forming the pin capture slot 128a. With the drawer and drawer pin 102a fully moved to the closed position, interlock swivel 122a returns to the first position as shown in FIG. 2B with drawer pin 102a disposed within pin capture slot 128a. Cam surface 138 of interlock swivel 122a disengages from cam follower 140a, allowing the cam follower 140a – forced by spring 106 and slide bar 146a – to return to its first position (shown in FIG. 2B), thereby re-opening gap 152 between the movable spring retainer 110 and the fixed spring retainer 108, as shown in FIG. 2B.

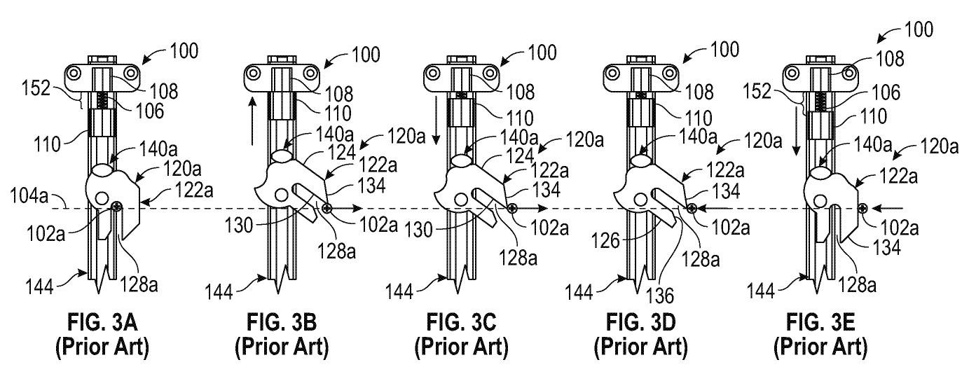

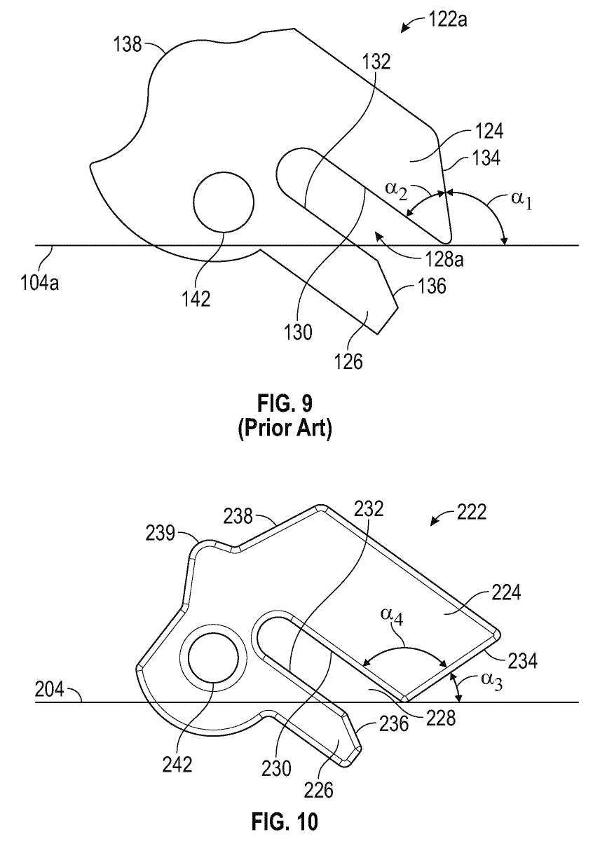

Referring to FIGS. 3A – 3E, due to manufacturing tolerances, drawer pin 102a may not be properly aligned with the pin capture slot 128a when the interlock swivel 122a is in the second (unlocked position), thereby preventing the drawer pin 102a from entering the pin capture slot 128a, thus preventing the drawer from closing properly. FIG. 3A shows the interlock swivel 122a in the first (locked) position with drawer pin 102a disposed within the pin capture slot 128a. FIG. 3B shows the interlock swivel 122a rotated counterclockwise to the second position as the drawer to which the drawer pin 102a is attached is moved toward the open position (left to right along drawer axis 104a). Although drawer pin 102a contacts first surface 130 near the open end of slot 128a, the angle of first surface 130 relative to the direction of movement of drawer pin 102a allows the drawer pin 102a to escape the pin capture slot 128a. This contact between first surface 130 and drawer pin 102a causes an upward deflection of the interlock mechanism 120a as the pin 102a is forced out of the pin capture slot 128a. As shown in FIG. 3C, after drawer pin 102a escapes the pin capture slot 128a, the interlock mechanism 120a will return to its undeflected position, and a lower end of a first end surface 130 and a lower end of end surface 134 of first leg 124 is disposed below the top of the drawer pin 102a. Accordingly, as shown in FIG. 3D, as the drawer to which the drawer pin 102a is attached is moved toward the closed position (right to left along drawer axis 104a in FIG. 3D), instead of contacting beveled surface 136 of second leg 126, drawer pin 102a contacts end surface 134 of the first leg 124. As shown in FIG. 9, end surface 134 is oriented at an obtuse (greater than 90 degrees) angle α₁ with respect to drawer axis 104a and an acute (less than 90 degrees) angle α₂ with respect to first surface 130.

Thus, as shown and FIGS. 3D and 3E, due to the angle of end surface 134, continued movement of drawer pin 102a to the left will cause the interlock swivel 122a to rotate clockwise as the drawer pin slides along end surface 134 and without enabling the drawer pin 102a to enter the pin capture slot 128a. Thus, interlock swivel 122a is returned to its first position with the drawer pin 102a disposed outside the pin capture slot 128a, as shown in FIG. 3E, referred to herein as a jam of the interlock swivel 122a or the lock mechanism 120a. Accordingly, the drawer to which drawer pin 102a is attached cannot be fully closed, and will not be locked in a closed position if another drawer of the cabinet or storage unit is opened. To correct the jammed interlock swivel 122a, the drawer to which drawer pin 102a is attached must be removed from the cabinet or storage unit and the interlock swivel 122a must be reset to the second position shown in FIG. 3B.

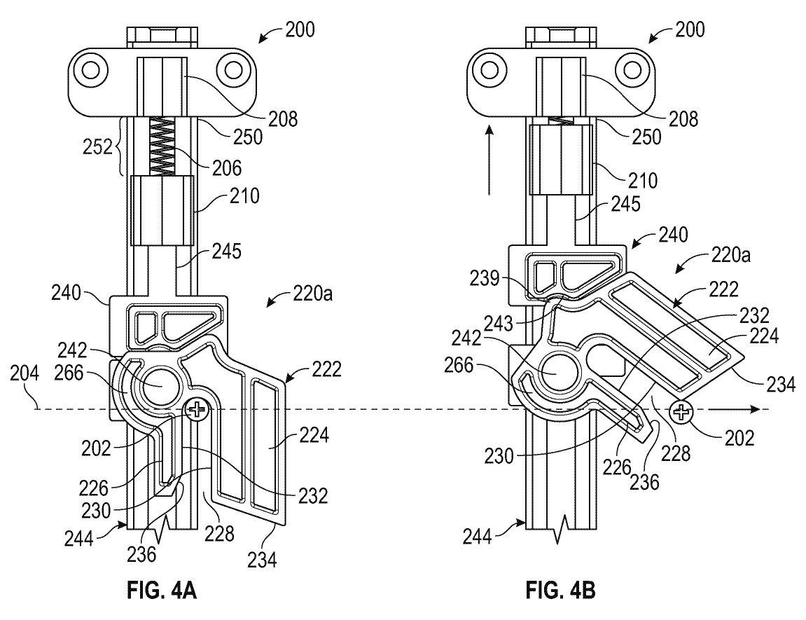

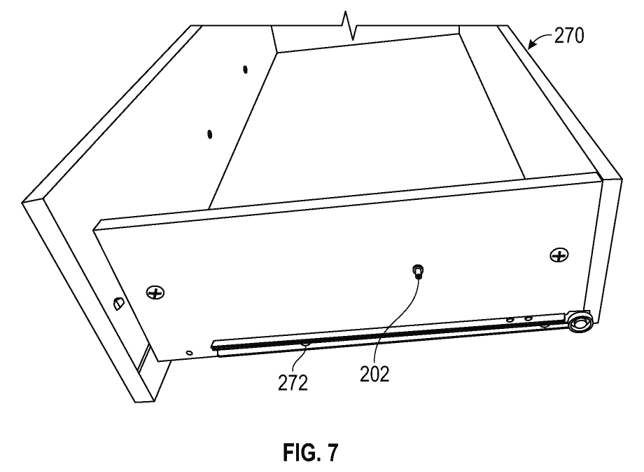

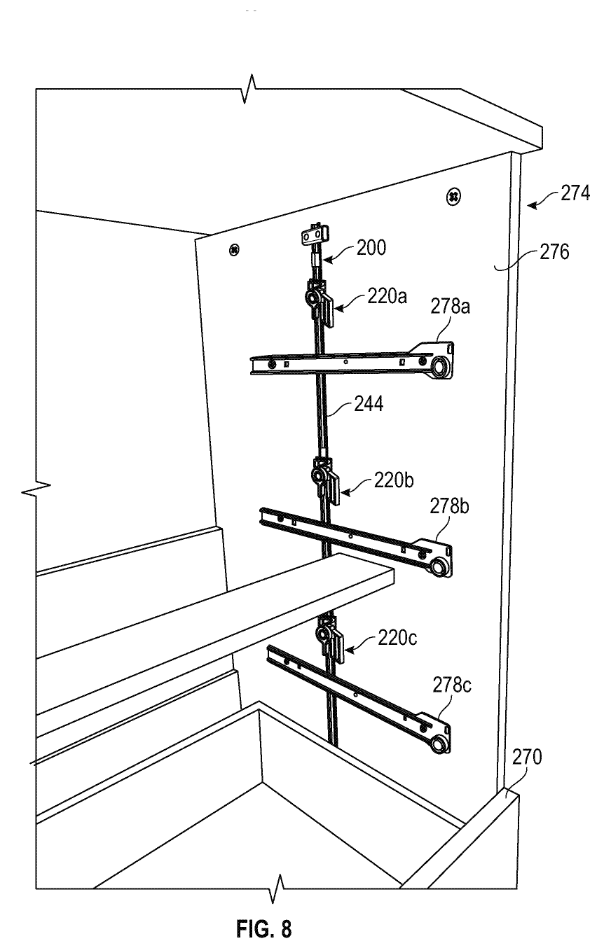

An assembly 200 configured to avoid jams to which the prior art interlock assembly 100 is susceptible is shown in FIGS. 4-6, 8, 10, and 11. As shown in FIG. 8, interlock assembly 200 may be attached to an inside wall 276 of a cabinet 274 or storage unit adjacent to drawers (a single drawer 270 is shown in FIG. 8) that are movable between open and closed positions on respective cabinet-mounted drawer slides 278a, 278b, 278c (a fourth cabinet-mounted drawer slide is blocked from view by drawer 270) along respective drawer axes (one axis 204 of one of the drawers is shown in FIGS. 4, 10, and 11). Interlock assembly may be disposed within a slot formed in inside wall 276 and retained within the slot by the cabinet-mounted drawer slides 278a, 278b, 278c. Single drawer 270, with drawer pin 202 and drawer-mounted drawer slide 272, is shown in FIG. 7. As shown in FIG. 8, interlock assembly 200 includes three lock mechanisms 220a, 220b, 220c (a fourth lock mechanism is blocked from view by drawer 270), each of which is engageable with a drawer pin, such as drawer pin 202, of a respective drawer, such as drawer 270. Interlock assembly 200 as shown in FIG. 8 has four lock mechanisms (three lock mechanisms 220a, 220b, 220c are visible) to accommodate four respective drawers. In other variants, the interlock assembly 200 may have two or four or more lock mechanisms to accommodate a like number of drawers. Interlock assembly 200 including two or more lock mechanisms, such as lock mechanisms 220a, 220b, 220c, combined with drawer pins of each of two or more respective drawers, such as drawer pin of 202 of drawer 270, may be referred to as an interlock system.

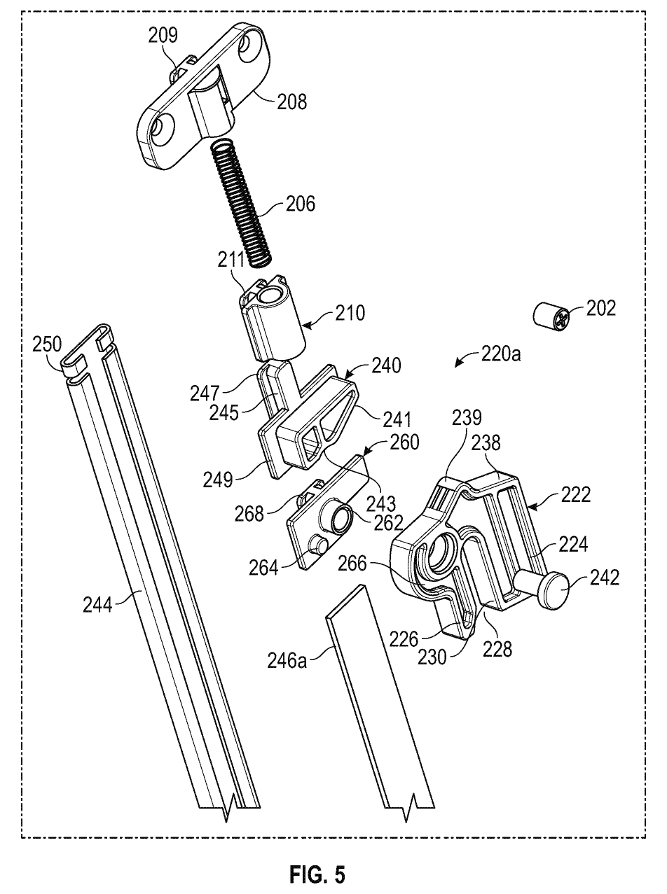

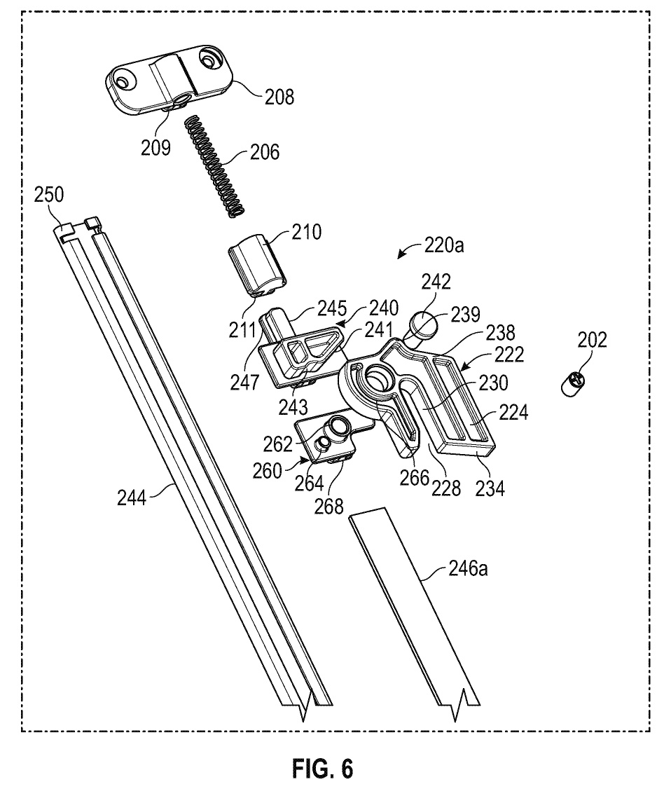

Lock mechanisms 220a, 220b, 220c are coupled to a vertical track 244, which may comprise a C-channel mounted to cabinet wall 276, so to be longitudinally movable along the length of the track 244. Referring to FIGS. 4A, 5, and 6, interlock assembly 200 includes a spring 206 disposed at a first end 250 (e.g., a top end) of track 244 between a fixed spring retainer 208 coupled to C-channel track 244 by a T-shaped slide 209 (see FIGS. 5, 6), or other slidable connection, and fixed to cabinet wall 276 by fasteners and a movable spring retainer 210 coupled to C-channel track 244 by a T-shaped slide 211 (see FIGS. 5, 6), or other slidable connection. Interlock assembly 200 may further include a first slide bar 246a (see FIGS. 5, 6) disposed within track 244 between lock mechanism 220a and lock mechanism 220b. Referring to FIG. 8, interlock assembly 200 may further include a second slide bar (not shown) disposed within track 244 between lock mechanism 220b and lock mechanism 220c, a third slide bar (now shown) disposed within track 244 between lock mechanism 220c and a lock mechanism blocked from view by drawer 270, and a fourth slide bar (now shown) disposed within track 244 between a second end (e.g., a lower end) of track 244 and the lock mechanism blocked from view by drawer 270.

Referring to FIGS. 4-6, lock mechanism 220a includes an interlock swivel 222 that is operatively coupled with a cam follower 240. Each lock mechanism 220b, 220c has an interlock swivel and cam follower that are identical to interlock swivel 222 and cam follower 240 of lock mechanism 220a. Interlock swivel 222 is engaged by drawer pin 202 to move the interlock swivel 222 between first (locked) position (FIG. 4A) and second (unlocked) position (FIG. 4B) as the respective drawer is moved between open and closed positions, as will be described herein.

As interlock swivels and cam followers of lock mechanisms 220a, 220b, and 220c are substantially identical in configuration and function, a detailed description will be limited to interlock swivel 222 and cam follower 240 of lock mechanism 220a.

Interlock swivel 222 includes a first leg 224 and a second leg 226 defining a pin capture slot 228 therebetween. Interlock swivel 222 is shown in a first (locked) position in FIG. 4A with drawer pin 202 disposed within the pin capture slot 228. With interlock swivel 222 of lock mechanism 220a in the first (locked) position, as shown in FIG. 4A, and the interlock swivels of lock mechanisms 220b, 220c in the locked positions, there is a gap 252 between fixed spring retainer 208 and movable spring retainer 210.

Referring to FIGS. 5 and 6, interlock swivel 222 is pivotably mounted to a pivot pin 242, which extends into a swivel base 260 which may include a cylindrical boss 262 extending into a bore formed in the interlock swivel 222. Swivel base 260 includes a swivel stop 264 that extends into a slot (not shown, but may be a mirror image of slot 266 formed on a front surface of the interlock swivel 222) formed in a back side of the interlock swivel 222 . Swivel base 260 has a T-shaped base slide 268, or other slidable connection, disposed within the track 244 to permit swivel base 260 and interlock swivel 222 to slide longitudinally along track 244. Interlock swivel 222 includes a cam surface 238 having a cam peak 239 engaged with a cam follower 240 mounted to a follower base 249 having a T-shaped base slide 247, or other slidable connection, disposed within track 244 to permit the follower base 249 and cam follower 240 to slide longitudinally along track 244. Cam follower 240 includes a cooperating cam surface operatively engaged with the cam surface 238 of the interlock swivel 222. The cooperating cam surface of the cam follower may include a ramp surface 241 and a cam detent 243. Follower base 249 may include a projection 245.

As the drawer to which drawer pin 202 is moved along drawer axis 204 from the closed position toward the open position (left to right in FIG. 4A and 4B), pin 202 contacts a first surface 230 of first leg 224 forming a first side of pin capture slot 228 to cause the interlock swivel 222 to pivot counterclockwise about a pivot axis defined by pin 242. As the drawer continues to be moved toward the open position, drawer pin 202 continues to cause counterclockwise rotation of the interlock swivel 222 until, as shown in FIG. 4B, interlock swivel 222 is sufficiently rotated to allow drawer pin 202 to escape pin capture slot 228. As interlock swivel 222 rotates counterclockwise, cam surface 238 of interlock swivel 222 (see FIGS. 5, 6) engages cam follower 240, with cam peak 239 sliding along ramp surface 241, to cause the cam follower 240 to move with respect to the interlock swivel 222 along track 244 toward first end 250 from a first position (FIG. 4A) to a second position (FIG. 4B), the second position being further from the pivot axis of pin 242 than the first position. When the interlock swivel 222 reaches the second (locked) position, as shown in FIG. 4B, the cam peak 239 of the interlock swivel 222 nests within the cam detent 243 of the cam follower 240 to releasably hold the interlock swivel 222 in the second (unlocked) position. Swivel stop 264 will contact an end of the slot (not shown, e.g., mirror image of slot 266) formed in the back side of the interlock swivel 222.

Movement of the cam follower 240 is transferred by projection 245 to the movable spring retainer 210 to reduce or substantially close the gap 252 between the movable spring retainer 210 and the fixed spring retainer 208, as shown in FIG. 4B. In other embodiments, e.g., with a larger top drawer, a slide bar (such as slide bar 246a) may be provided in track 244 between an end of projection 245 and movable spring retainer 210 to transfer motion of the cam follower 240 to the movable spring retainer 210. With little or no gap between the movable spring retainer 210 and the fixed spring retainer 208, any attempt to open another drawer and rotate the interlock swivel of the associated lock mechanism will be blocked. An attempt to open the drawer associated with lock mechanism 220b will be blocked because the slide bar disposed between lock mechanism 220b and lock mechanism 220a will prevent relative longitudinal movement of the cam follower of lock mechanism 220b, thereby preventing rotation of the interlock swivel of lock mechanism 220b from the first (locked) position to the second (unlocked) position. An attempt to open the drawer associated with lock mechanism 220c will be blocked because the slide bar disposed between lock mechanism 220c and lock mechanism 220b and the slide bar disposed between lock mechanism 220b and lock mechanism 220a will prevent relative longitudinal movement of the cam follower of lock mechanism 220c, thereby preventing rotation of the interlock swivel of lock mechanism 220c from the first (locked) position to the second (unlocked) position.

Similarly, if the interlock swivel of lock mechanism 220b were rotated counterclockwise from the first (locked) position to the second (unlocked) position by movement of the drawer associated with lock mechanism 220b from the closed position to the open position, the resulting longitudinal movement of the cam follower of lock mechanism 220b due to rotation of the interlock swivel of lock mechanism 220b will reduce or substantially close the gap 252 between the movable spring retainer 210 and the fixed spring retainer 208, as shown in FIG. 4B, thereby blocking opening of the drawers associated with lock mechanisms 220a and 220c. If the interlock swivel of lock mechanism 220c were rotated counterclockwise from the first (locked) position to the second (unlocked) position by movement of the drawer associated with lock mechanism 220c from the closed position to the open position, the resulting longitudinal movement of the cam follower of lock mechanism 220c due to rotation of the interlock swivel of lock mechanism 220c will reduce or substantially close the gap 252 between the movable spring retainer 210 and the fixed spring retainer 208 as shown in FIG. 4B, thereby blocking opening of the drawers associated with lock mechanisms 220a and 220b.

As the drawer to which drawer pin 202 is attached is moved from the open position to the closed position (right to left along drawer axis 204 in FIGS. 4A and 4B) and if the drawer pin 202 is properly located, the drawer pin 202 will contact a beveled second end surface 236 of second leg 226 to begin rotating the interlock swivel 222 clockwise about pivot pin 242. If the drawer is closed with sufficient force, the force of the drawer pin 202 on the interlock swivel 222 will cause the cam peak 239 of the interlock swivel 222 to overcome the cam detent 243 of the cam follower 240 to enable the interlock swivel 222 to rotate freely toward the first position. As the drawer is further moved toward the closed position and interlock swivel 222 rotates clockwise, drawer pin 202 will slide along the second surface 232 of second leg 226 forming the pin capture slot 228. With the drawer and drawer pin 202 fully moved to the closed position, interlock swivel 222, returns to the first position as shown in FIG. 4A with the drawer pin 202 disposed within the pin capture slot 228.

Referring to FIG. 4B, if drawer pin 202 is not properly aligned with the pin capture slot 228 when the interlock swivel 222 is in the second (unlocked) position, e.g., due to manufacturing tolerances, drawer pin 202 will contact first end surface 234 of first leg 224. However, due to the configuration of the interlock swivel 222, the drawer pin 202 will not cause the interlock swivel 222 to rotate to the first (locked) position without the pin capture slot 228 capturing the drawer pin 202, as shown in FIG. 3E and described above.

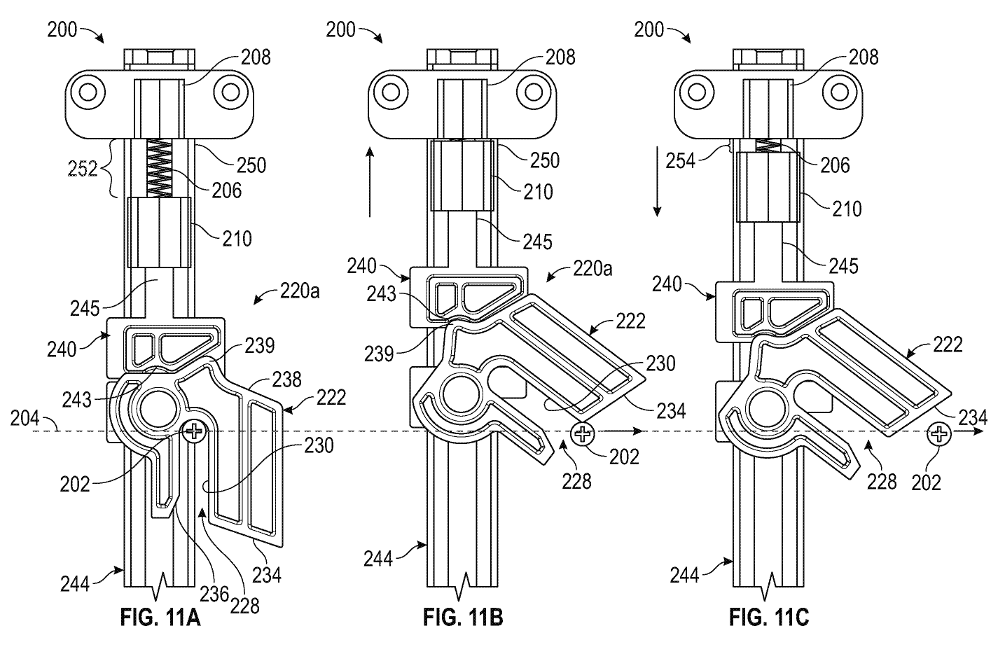

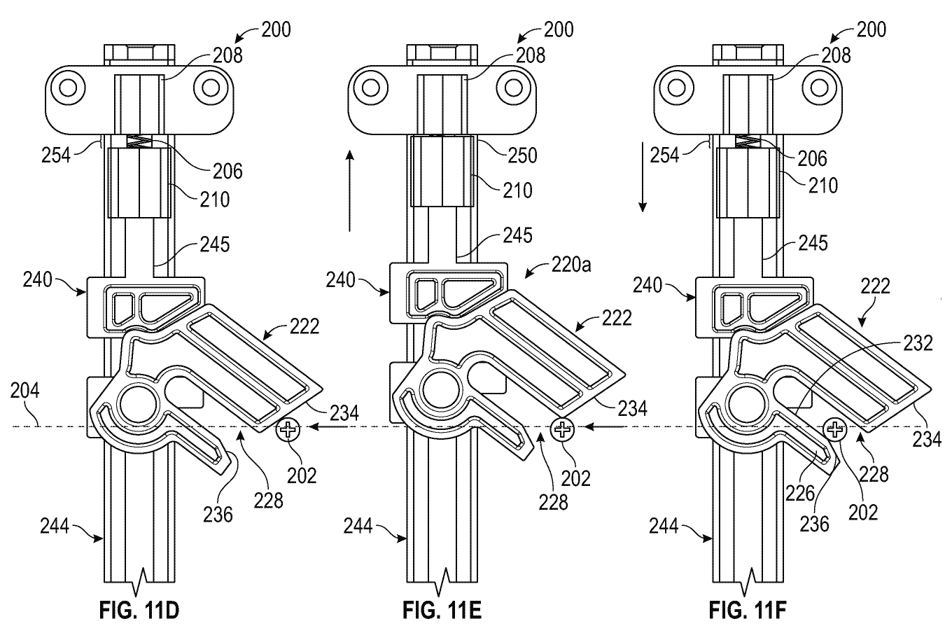

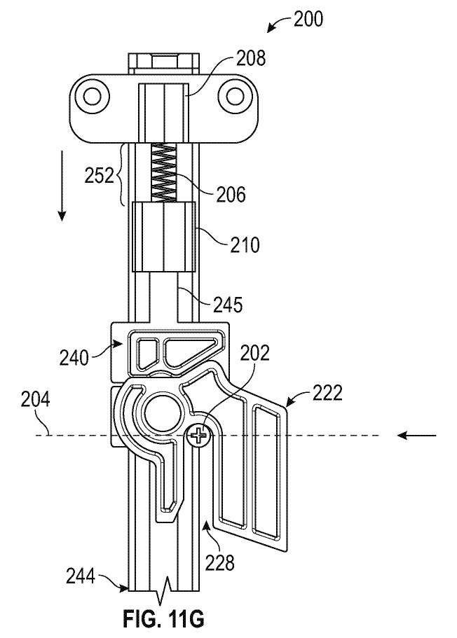

FIG. 11A shows the interlock swivel 222 of lock mechanism 220a in the first (locked) position with drawer pin 202 disposed within the pin capture slot 228. FIG. 11B shows the interlock swivel 222 rotated counterclockwise to the second (unlocked) position with the cam peak 239 of the interlock swivel 222 nested within the cam detent 243 of the cam follower 240 as the drawer to which the drawer pin 202 is attached is moved toward the open position. Although drawer pin 202 contacts first surface 230 near the open end of slot 228, the angle of first surface 230 relative to the direction of movement of drawer pin 202 allows the drawer pin 202 to escape the pin capture slot 228. This contact between first surface 230 and drawer pin 202 after the interlock swivel has reached its rotational motion limit causes an upward deflection of the lock mechanism 220a as the pin 202 is forced out of the pin capture slot 228. As shown in FIG. 11B, this deflection of the lock mechanism 220a may cause the movable spring retainer 210 to contact the fixed spring retainer 208.

As shown in FIG. 11C, after drawer pin 202 escapes the pin capture slot 228, the lock mechanism 220a will return to its undeflected position, leaving a partial gap 254 between the movable spring retainer 210 and the fixed spring retainer 208 and so that a lower end of first end surface 234 of first leg 224 is disposed below the top of the drawer pin 202. Partial gap 254 is smaller than gap 252 of FIG. 11A as the cam follower 240 is pushed up by the cam surface 238 and cam peak 239. As shown in FIG. 11D, as the drawer to which the drawer pin 202 is attached is moved from the open position toward the closed position (right to left along drawer axis 204 in FIG. 11), instead of contacting beveled surface 236 of second leg 226, drawer pin 202 contacts end surface 234 of the first leg 224. As shown in FIG. 10, end surface 234 is oriented at an acute (less than 90 degrees) angle α₃ with respect to drawer axis 204 (i.e., with respect to the direction of movement of the drawer pin 202) and an obtuse (greater than 90 degrees) angle α₄ with respect to first surface 230.

Thus, as shown and FIGS. 11E and 11F, due to the movement of the drawer pin 202 over the end surface 234 and due to the angle of the end surface 234 relative to the direction of movement of drawer pin 202, continued movement of drawer pin 202 to the left will push the lock mechanism 220a upwardly. The partial gap 254 between the fixed spring retainer 208 and the movable spring retainer 210 allows the lock mechanism 220a to deflect upwardly, thereby permitting the drawer pin 202 to pass below the lower end of the first end surface 234 of first leg 224 and into the pin capture slot 228. As shown in FIGS. 11F and 11G, as the drawer is further moved toward the closed position, and interlock swivel 222 rotates clockwise, drawer pin 202 will slide along the second surface 232 of second leg 226 forming the pin capture slot 228. With the drawer and drawer pin 202 fully moved to the closed position, interlock swivel 222, returns to the first position as shown in FIG. 11G with the drawer pin 202 disposed within the pin capture slot 228 and with the cam follower 240 returned to its first position to thereby re-open gap 252.

Each of the lock mechanisms of the stacked array of two or more lock mechanisms of interlock assembly 200 will have an interlock swivel configured in the same manner as interlock swivel 222 described herein. Each interlock swivel will have a first end surface of its first leg oriented at an obtuse angle with respect to a drawer axis (i.e., direction of movement of the drawer pin) or an acute angle with respect to a first surface of the pin capture slot formed by the first leg. Thus if a drawer pin of a respective drawer associated with any of the locking mechanisms is misaligned with respect to the pin capture slot of the corresponding interlock swivel, and the drawer pin contacts the end surface of the first leg of the interlock swivel while the respective drawer is being closed, the angle of the end surface of the interlock swivel will cause the lock mechanism to deflect longitudinally along the interlock assembly track to permit the misaligned pin to enter the pin capture slot of the interlock swivel.

All possible combinations of elements and components described in the specification or recited in the claims are contemplated and considered to be part of this disclosure. It should be appreciated that all combinations of the foregoing concepts and additional concepts discussed in greater detail herein (provided such concepts are not mutually inconsistent) are contemplated as being part of the inventive subject matter described herein. In particular, all combinations of claimed subject matter appearing at the end of this disclosure are contemplated as being part of the inventive subject matter disclosed herein.

While the subject matter of this disclosure has been described and shown in considerable detail with reference to certain illustrative examples, including various combinations and sub-combinations of features, those skilled in the art will readily appreciate other embodiments and variations and modifications thereof as encompassed within the scope of the present disclosure.

Moreover, the descriptions of such examples, combinations, and sub-combinations is not intended to convey that the claimed subject matter requires features or combinations of features other than those expressly recited in the claims. Accordingly, the scope of this disclosure is intended to include all modifications and variations encompassed within the scope of the following appended claims.

1. An interlock swivel for an interlock system of a cabinet having two or more drawers, each drawer being movable between a closed position and an open position, and each drawer including a drawer pin movable with the respective drawer, wherein the interlock swivel is mounted with respect to the cabinet so as to be movable between a first position and a second position, and wherein the interlock swivel comprises:
a first leg; and
a second leg spaced apart from the first leg to define an open-ended pin capture slot between the first leg and the second leg, wherein the interlock swivel is constructed and arranged to be in the first position with the drawer pin of a respective one of the two or more drawers disposed within the pin capture slot when the respective drawer is in the closed position, and wherein movement of the respective drawer from the closed position to the open position causes the drawer pin to engage the first leg and cause the interlock swivel to move from the first position to the second position, and wherein the first leg includes an end surface oriented at an obtuse angle with respect to a side of the first leg forming one side of the pin capture slot, so that if the drawer pin contacts the end surface of the first leg of the interlock swivel disposed in the second position as the respective drawer is moved from the open position to the closed position, inter-engagement between the drawer pin and the end surface will cause the interlock swivel to deflect to enable the drawer pin to enter the pin capture slot so that continued movement of the respective drawer to the closed position will return the interlock swivel to the first position with the drawer pin of the respective drawer disposed in the pin capture slot.

2. An interlock assembly for a cabinet having two or more drawers, wherein the interlock assembly comprises a lock mechanism associated with each of the two or more drawers, and wherein each lock mechanism includes the interlock swivel of claim 1.

3. An interlock system for a cabinet having two or more drawers, wherein the interlock system comprises the interlock assembly of claim 2 and a drawer pin associated with each of the two or more drawers.

4. A lock mechanism for an interlock assembly for a cabinet having two or more drawers, each drawer being movable between a closed position and an open position, and each drawer including a drawer pin movable with the respective drawer, wherein the lock mechanism comprises:
the interlock swivel of claim 1, wherein the interlock swivel is configured to pivot about a pivot axis between the first position and the second position, and wherein the interlock swivel includes a cam surface; and
a cam follower including a cooperating cam surface operative engaged with the cam surface of the interlock swivel so that movement of the interlock swivel from the first position to the second position causes the cam follower to move from a first position to a second position, wherein the second position is further from the pivot axis than the first position.

5. An interlock assembly for a cabinet having two or more drawers, wherein the interlock assembly comprises:
the lock mechanism of claim 4 associated with each of the two or more drawers;
a track having a first end and a second end, wherein each lock mechanism is attached to a different longitudinally-spaced position on the track, and wherein at least the cam follower of each lock mechanism is configured to move longitudinally along the track;
a spring disposed at a position along the track between a fixed spring retainer and a movable spring retainer; and
one or more slide bars, each slide bar being coupled to the track between one lock mechanism and an adjacent lock mechanism, and wherein each slide bar is configured to transfer motion of the cam follower of the one lock mechanism from the first position to the second position to the adjacent lock mechanism.

6. An interlock assembly of claim 5, further comprising a slide bar coupled to the track between an uppermost one of the lock mechanisms and the movable spring retainer, wherein each slide bar is configured to transfer motion of the cam follower of the uppermost lock mechanism to the movable spring retainer.

7. An interlock swivel for an interlock system of a cabinet having two or more drawers, each drawer being movable along a drawer axis between a closed position and an open position, and each drawer including a drawer pin movable with the respective drawer, wherein the interlock swivel is mounted with respect to the cabinet so as to be movable between a first position and a second position, and wherein the interlock swivel comprises:
a first leg; and
a second leg spaced apart from the first leg to define an open-ended pin capture slot between the first leg and the second leg, wherein the interlock swivel is constructed and arranged to be in the first position with the drawer pin of a respective one of the two or more drawers disposed within the pin capture slot when the respective drawer is in the closed position, and wherein movement of the respective drawer from the closed position to the open position causes the drawer pin to engage the first leg and cause the interlock swivel to move from the first position to the second position, and wherein the first leg includes an end surface oriented at an acute angle with respect to the drawer axis when the interlock swivel is in the second position, so that if the drawer pin contacts the end surface of the first leg of the interlock swivel disposed in the second position as the respective drawer is moved from the open position to the closed position, inter-engagement between the drawer pin and the end surface will cause the interlock swivel to deflect to enable the drawer pin to enter the pin capture slot so that continued movement of the respective drawer to the closed position will return the interlock swivel to the first position with the drawer pin of the respective drawer disposed in the pin capture slot.

8. An interlock assembly for a cabinet having two or more drawers, wherein the interlock assembly comprises a lock mechanism associated with each of the two or more drawers, and wherein each lock mechanism includes the interlock swivel of claim 7.

9. An interlock system for a cabinet having two or more drawers, wherein the interlock system comprises the interlock assembly of claim 8 and a drawer pin associated with each of the two or more drawers.

10. A lock mechanism for an interlock assembly for a cabinet having two or more drawers, each drawer being movable between a closed position and an open position, and each drawer including a drawer pin movable with the respective drawer, wherein the lock mechanism comprises:
the interlock swivel of claim 7, wherein the interlock swivel is configured to pivot about a pivot axis between the first position and the second position, and wherein the interlock swivel includes a cam surface; and
a cam follower including a cooperating cam surface operative engaged with the cam surface of the interlock swivel so that movement of the interlock swivel from the first position to the second position causes the cam follower to move from a first position to a second position, wherein the second position is further from the pivot axis than the first position.

11. An interlock assembly for a cabinet having two or more drawers, wherein the interlock assembly comprises:
the lock mechanism of claim 10 associated with each of the two or more drawers;
a track having a first end and a second end, wherein each lock mechanism is attached to a different longitudinally-spaced position on the track, and wherein at least the cam follower of each lock mechanism is configured to move longitudinally along the track;
a spring disposed at a position along the track between a fixed spring retainer and a movable spring retainer; and
one or more slide bars, each slide bar being coupled to the track between one lock mechanism and an adjacent lock mechanism, and wherein each slide bar is configured to transfer motion of the cam follower of the one lock mechanism from the first position to the second position to the adjacent lock mechanism.

12. An interlock assembly of claim 11, further comprising a slide bar coupled to the track between an uppermost one of the lock mechanisms and the movable spring retainer, wherein each slide bar is configured to transfer motion of the cam follower of the uppermost lock mechanism to the movable spring retainer.
